(19) United States
(12) Patent Application Publication
(10) Pub. No.: US 2023/0342818 A1
(43) Pub. Date: Oct. 26, 2023

(54) SYSTEMS AND METHODS FOR PUBLISHING MARKETING CAMPAIGNS OVER DIGITAL PLATFORMS

(71) Applicant: Intellemo, Inc., Dover, DE (US)

(72) Inventor: Saurabh Gupta, Mathura, Uttar Pradesh (IN)

(73) Assignee: Intellemo, Inc, Dover, DE (US)

(21) Appl. No.: 17/728,666

(22) Filed: Apr. 25, 2022

(51) Int. Cl. G06Q 30/02

(52) U.S. Cl. CPC G06Q 30/0276

(57) ABSTRACT

Present disclosure describes techniques for publishing at least one marketing campaign over one or more digital platforms. The techniques include the step of receiving one or more parameters associated with at least one product or at least one service from a business owner and retrieving a plurality of marketing campaign recommendations associated with the at least one product or the at least one service from a database. The techniques further comprise the step of selecting a marketing campaign recommendation at least based on one or more preferences of the business owner, automatically customizing the selected marketing campaign recommendation, at least based on metadata associated with the business owner and the one or more parameters, to generate a customized marketing campaign, and displaying the customized marketing campaign to the business owner. The techniques further comprise the step of receiving one or more inputs on the customized marketing campaign displayed to the business owner and publishing the customized marketing campaign on the one or more digital platforms based on the received one or more inputs.

### BACKGROUND OF THE INVENTION

### Technical Field

The present disclosure relates to systems and methods for publishing marketing campaigns via Internet.

### Description of the Related Art

Millions of businesses are competing every day to seek the attention of customers. It is one of the biggest challenges for the businesses to cut through the plethora of messages found in digital and traditional media platforms. By regularly communicating with their respective target audience, a business can improve its visibility. This communication is largely achieved through marketing campaigns done on various digital platforms.

Marketing campaigns are designed, organized, and strategized with company goals in mind. The goals may include building a brand image, introducing a new product/service, increasing sales of a product already available in the market, or even reducing the impact of negative news. Defining a marketing campaign's goal usually commands how much marketing is needed and what media are most effective for reaching a specific segment of the population.

Marketing campaigns intend to reach consumers in a variety of ways, from mailing brochures to coordinating a social media blitz. Marketing campaigns contain a combination of media, including but not limited to email, print advertising, television or radio advertising, pay-per-click, and social media platforms, etc.

However, doing digital marketing via internet is a struggle for most of the businesses. The businesses need professional expertise related to design, marketing research, content, technology, and communication to make their business grow. A lot of businesses have great products, but they fail if they are not able to do proper digital marketing. The current alternatives are time consuming, costly and require lot of coordination between multiple people and processes.

For the aforementioned reasons, there exist a need in the art to provide a technique which overcomes the above-mentioned problems and automatically create customized marketing campaigns for the business based on their business goals.

### SUMMARY OF THE INVENTION

In one non-limiting embodiment of the present disclosure, a method of publishing at least one marketing campaign over one or more digital platforms is disclosed. The method comprises receiving one or more parameters associated with at least one product or at least one service from a business owner and retrieving a plurality of marketing campaign recommendations associated with the at least one product or the at least one service from a database, each marketing campaign recommendation comprising a pre-built design, content, target audience and configuration. The method further comprises selecting a marketing campaign recommendation from the plurality of marketing campaign recommendations at least based on one or more preferences of the business owner, automatically customizing the selected marketing campaign recommendation, at least based on metadata associated with the business owner and the one or more parameters, to generate a customized marketing campaign, and displaying the customized marketing campaign to the business owner. The method further comprises receiving, from the business owner, one or more inputs on the customized marketing campaign displayed to the business owner and publishing the customized marketing campaign on the one or more digital platforms based on the received one or more inputs.

In another non-limiting embodiment of the present disclosure, selecting the marketing campaign recommendation from the plurality of marketing campaign recommendations comprises comparing the one or more preferences of the business owner with each of the plurality of marketing campaign recommendations and determining the marketing campaign recommendation that matches the one or more preferences of the business owner.

In yet another non-limiting embodiment of the present disclosure, the one or more parameters comprises an image associated with the at least one product or the at least one service, details associated with the at least one product or the at least one service, a target objective for the at least one product or the at least one service, target audience, location details, and a budget for marketing campaign.

In yet another non-limiting embodiment of the present disclosure, the metadata associated with the business owner comprises a brand logo, a brand color, a brand slogan/tagline, brand features, and URL/website link.

In yet another non-limiting embodiment of the present disclosure, the one or more preferences of the business owner is defined based at least on type of previous marketing campaigns selected by the business owner.

In yet another non-limiting embodiment of the present disclosure, the one or more inputs at least comprises one or more changes to be applied to the customized marketing campaign displayed to the business owner.

In yet another non-limiting embodiment of the present disclosure, the method further comprises automatically optimizing the published marketing campaign at least based on a daily budget and a target objective of the business owner.

In yet another non-limiting embodiment of the present disclosure, the marketing campaign comprises one or more of: a structure of campaign, audiences, keywords, product catalogue, service catalogue and ads or ad sets across advertising manager dashboards of the one or more digital platforms.

In yet another non-limiting embodiment of the present disclosure, a system for publishing at least one marketing campaign over one or more digital platforms is disclosed. The system comprises a memory for storing a plurality of instructions, a processing unit in communication with the memory capable of executing the plurality of instructions, and a user interface in communication with the memory and the processing unit. The user interface is configured to receive one or more parameters associated with at least one product or at least one service from a business owner. The processing unit is configured to retrieve a plurality of marketing campaign recommendations associated with the at least one product or the at least one service from a database, each marketing campaign recommendation comprising a pre-built design, content, target audience and configuration. The processing unit is further configured to select a marketing campaign recommendation from the plurality of marketing campaign recommendations at least based on one or more preferences of the business owner and automatically customize the selected marketing campaign recommendation, at least based on metadata associated with the business owner and the one or more parameters, to generate a customized marketing campaign. The system further comprises a display unit configured to display the customized marketing campaign to the business owner. The user interface is configured to receive, from the business owner, one or more inputs on the customized marketing campaign displayed to the business owner, and the processing unit is configured to publish the customized marketing campaign on the one or more digital platforms based on the received one or more inputs.

In yet another non-limiting embodiment of the present disclosure, to select the marketing campaign recommendation from the plurality of marketing campaign recommendations, the processing unit is configured to compare the one or more preferences of the business owner with each of the plurality of marketing campaign recommendations and determine the marketing campaign recommendation that matches the one or more preferences of the business owner.

In yet another non-limiting embodiment of the present disclosure, the one or more inputs at least comprises one or more changes to be applied to the customized marketing campaign displayed to the business owner, or an approval on the customized marketing campaign for publishing on the one or more digital platforms.

In yet another non-limiting embodiment of the present disclosure, to publish the customized marketing campaign on the one or more digital platforms, the processing unit is configured to update the customized marketing campaign based on the one or more changes received from the business owner and publish the updated marketing campaign on the one or more digital platforms, the one or more digital platforms for publishing the updated marketing campaign being selected by the business owner.

In yet another non-limiting embodiment of the present disclosure, a non-transitory computer-readable medium having computer-readable instructions is disclosed. The instruction when executed by a processor causes the processor to perform operations of obtaining one or more parameters associated with at least one product or at least one service from a business owner, and retrieving a plurality of marketing campaign recommendations associated with the at least one product or the at least one service from a database, each marketing campaign recommendation comprising a pre-built design, content, target audience and configuration. The instruction when executed by the processor further causes the processor to perform operations of selecting a marketing campaign recommendation from the plurality of marketing campaign recommendations at least based on one or more preferences of the business owner, automatically customizing the selected marketing campaign recommendation, at least based on metadata associated with the business owner and the one or more parameters, to generate a customized marketing campaign, displaying the customized marketing campaign to the business owner, obtaining, from the business owner, one or more inputs on the customized marketing campaign displayed to the business owner; and publishing the customized marketing campaign on the one or more digital platforms based on the received one or more inputs.

The foregoing summary is illustrative only and is not intended to be in any way limiting. In addition to the illustrative embodiments, and features described above, further embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and with reference to the accompanying Figures, in which.

FIG. 1 shows an exemplary environment for publishing at least one marketing campaign over one or more digital platforms, in accordance with some embodiments of the present disclosure;

FIG. 2 illustrates an exemplary environment for creating marketing campaigns for products/services and publishing the marketing campaigns, in accordance with some embodiments of the present disclosure;

FIG. 3(a)-(d) illustrate an exemplary application flow for creating marketing campaign for a product and publishing the marketing campaign over multiple digital platforms, in accordance with some embodiments of the present disclosure;

FIG. 4 illustrates a block diagram of a system for publishing at least one marketing campaign over one or more digital platforms, in accordance with some embodiments of the present disclosure;

FIG. 5 depicts a flowchart illustrating an exemplary method for publishing at least one marketing campaign over one or more digital platforms, in accordance with some embodiments of the present disclosure;

FIG. 6 illustrate an exemplary application window for searching and selecting a campaign recommendation from a plurality of campaign recommendations, in accordance with some embodiments of the present disclosure;

FIG. 7(a)-(d) illustrate exemplary application window for budgeting ad goals at various levels, in accordance with some embodiments of the present disclosure;

FIG. 8 illustrates a block diagram illustrating an exemplary computer system for implementing embodiments consistent with the present disclosure;

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that these embodiments are not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The expressions like “at least one” and “one or more” may be used interchangeably or in combination throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

In an embodiment of the present disclosure, techniques for publishing at least one marketing campaign over one or more digital platforms. The techniques according to the present disclosure receiving one or more parameters associated with at least one product or at least one service from a business owner and retrieving a plurality of marketing campaign recommendations associated with the at least one product or the at least one service from a database. The techniques further comprise the step of selecting a marketing campaign recommendation at least based on one or more preferences of the business owner, automatically customizing the selected marketing campaign recommendation, at least based on metadata associated with the business owner and the one or more parameters, to generate a customized marketing campaign, and displaying the customized marketing campaign to the business owner. The techniques further comprise the step of receiving, from the business owner, one or more inputs on the customized marketing campaign displayed to the business owner and publishing the customized marketing campaign on the one or more digital platforms based on the received one or more inputs.

Accordingly, the techniques of the present disclosure facilitate automatic customization of content for the marketing campaign based on their business goals and preferences. Thereafter, marketing campaign gets published on various social media advertising platforms and gets optimized without any requirement of skillful intervention.

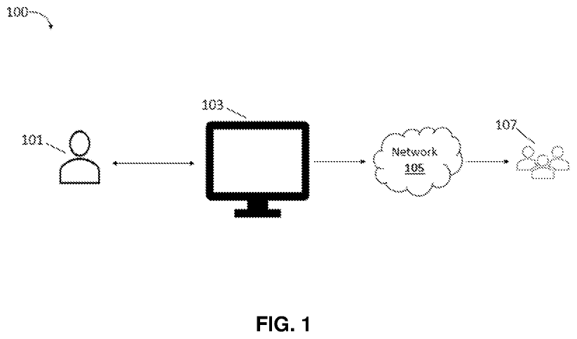

FIG. 1 shows an exemplary environment 100 for publishing at least one marketing campaign over one or more digital platforms, in accordance with some embodiments of the present disclosure.

The environment 100 may comprise a business owner 101, a system 103 for generating and publishing marketing campaign 103, and number of users 107 connected through a network or communication network 105. The network 105 may be the internet, intranet, a local area network (LAN), a wide area network (WAN), wireless LAN (WLAN), wireless fidelity (Wi-Fi), and similar networks. In one non-limiting embodiment, the business owner 101 may forward a number of parameters and data associated with a product/service to the system 103 for which customized marketing campaign is needed.

The system 103 may comprise a plurality of readymade marketing campaign templates related to different types of products and services, which are pre-defined within the system 103. The system 103 may select a marketing campaign template that matches the product/service and are also matching the preferences of the business owner 101. In one non-limiting embodiment, the plurality of readymade marketing campaign templates may be present at a server end (not shown) and may be retrieved from the server.

The system 103 may then customize the selected marketing campaign based on a brand configuration of business owner 101 and product/service details received from the business owner 101. The customized marketing campaign may be published over one or more digital or social media platforms for reaching a plurality of user 107 present on the digital or social media platforms. In one non-limiting embodiment of the present disclosure, the customized marketing campaign may be edited by the business owner 101 and then published over one or more digital or social media platforms. In one non-limiting embodiment, digital or social media platforms include, but not limited to, Facebook, Instagram, Meta Ads Network, LinkedIn, Google Ads Network, YouTube, Pinterest, Quora, Twitter, TikTok, etc.

In one non-limiting embodiment of the present disclosure, the readymade customized marketing campaign may comprise ad or ad-set, relevant keywords, recommended content and audience, website link or URL of the business owner.

Thus, the system 103 facilitate automatic customization of marketing campaign associated with a product/service based on their business goals and preferences. Thereafter, the marketing campaign gets published on various social media advertising platforms and gets optimized without any requirement of skillful intervention.

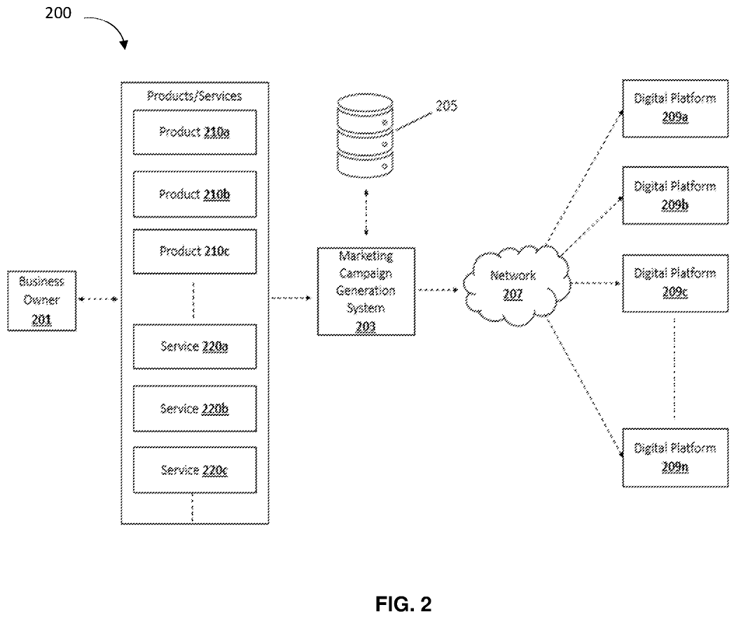

FIG. 2 illustrates an exemplary environment 200 for creating marketing campaigns for products/services and publishing the marketing campaigns, in accordance with some embodiments of the present disclosure.

The environment 200 may comprise a business owner 201, a marketing campaign generation system 203, a server 205 in communication with a number of digital platforms 290a, 290b, 290c, . . . 290n through the network 207. The network 207 may be the internet, intranet, a local area network (LAN), a wide area network (WAN), wireless LAN (WLAN), wireless fidelity (Wi-Fi), and similar networks.

The business owner 201 may offer a number of different products/services to consumers. The products/services may comprise Product 210a, Product 210b, Product 210c, . . . . Service 220a, Service 220b, Service 220c . . . , etc. The products/services may comprise new as well as already existing products/services.

The business owner 201 may communicate a request comprising one or more parameters associated with at least one product or service to a marketing campaign generation system 203 through a user device. The user device may be a mobile phone, smart phone, mobile node, radio terminal, personal digital assistant, tablet computer, laptop computer, or the like with communication capabilities.

In an embodiment, the marketing campaign generation system 203 may be an application hosted on the user device of the business owner 201 or server 205, for example, may be an application associated with social networking capabilities, to allow the business owner 201 to send or broadcast marketing campaigns to one or more other user devices through a number of digital platforms 290a, 290b, 290c, . . . 290n. In an exemplary embodiment, digital platforms 290a, 290b, 290c, . . . 290n include, but not limited to, Facebook, Instagram, Meta Ads Network, LinkedIn, Google Ads Network, YouTube, Pinterest, Quora, Twitter, TikTok, etc. In one non-limiting embodiment, the application may be a standalone application, or may be a “plug-in” to existing commercial social networking applications.

The one or more parameters may comprise one or more of: an image associated with the at least one product or the at least one service, details associated with the at least one product or the at least one service, a target objective for the at least one product or the at least one service, target audience, location details, and a budget for marketing campaign. However, the one or more parameters are not limited to above examples and any other parameter that is required for creating marketing campaign of products/services is well within the scope of present disclosure.

The marketing campaign generation system 203 may comprise a plurality of marketing campaign recommendations or readymade templates associated with various products/services. Each marketing campaign recommendation or readymade template may comprise a respective advertisement design, content, recommended audience and landing page facility. The readymade templates may be predesigned by the system administrator and may be updated based on upcoming product/services and business needs.

In one non-limiting embodiment of the present disclosure, the plurality of marketing campaign recommendations may be stored in a database of the server 205 and may be retrieved from the server 205. In another non-limiting embodiment of the present disclosure, the plurality of marketing campaign recommendations may be retrieved from the memory of the marketing campaign generation system 203.

The business owner 201 may have specified or defined the business preferences to the marketing campaign generation system 203, while coming onboard or while setting up an application of marketing campaign generation system 203 on a computing device/user device of the business owner 201. The business preference may comprise a type of marketing campaign preferred by a business, daily budget for the marketing campaign, and goals of the business, etc. However, the business preferences are not limited to above examples, any other type of business preference is well within the scope of the present disclosure.

In an embodiment, the marketing campaign generation system 203 may select a marketing campaign recommendation from the plurality of marketing campaign recommendations or readymade templates at least based on the one or more preferences of the business owner 201 provided by the them earlier. In one non-limiting embodiment, the business owner 201 may convey the business preferences with respect to a particular product/service along with the request for generating the marketing campaign.

The marketing campaign generation system 203 may then customize the selected marketing campaign based on a brand configuration of the business owner 201, which includes applying a brand logo, a brand color, a brand slogan/tagline, brand features, and URL/website link, etc., specific to the business owner 201. The customized marketing campaign may be displayed to the business owner for approval and may then be published over a number of digital platforms through the network 207. In one non-limiting embodiment, the business owner 201 may update the customized marketing campaign and then allow the marketing campaign generation system 203 to publish the marketing campaign.

In one non-limiting embodiment of the present disclosure, the marketing campaign generation system 203 may comprise a budget engine for finding avenues and maximizing the revenue across platforms. The budget engine may optimize the published marketing campaign in terms of target audience, location and other preferences to increase the revenue of the business owner 201.

Thus, the marketing campaign generation system 203 provides a readymade content that gets automatically customized as per brand preferences of the business, thereby facilitating one click marketing to business owners where the campaigns are automatically created, targeting is set and ads are launched across multiple platforms.

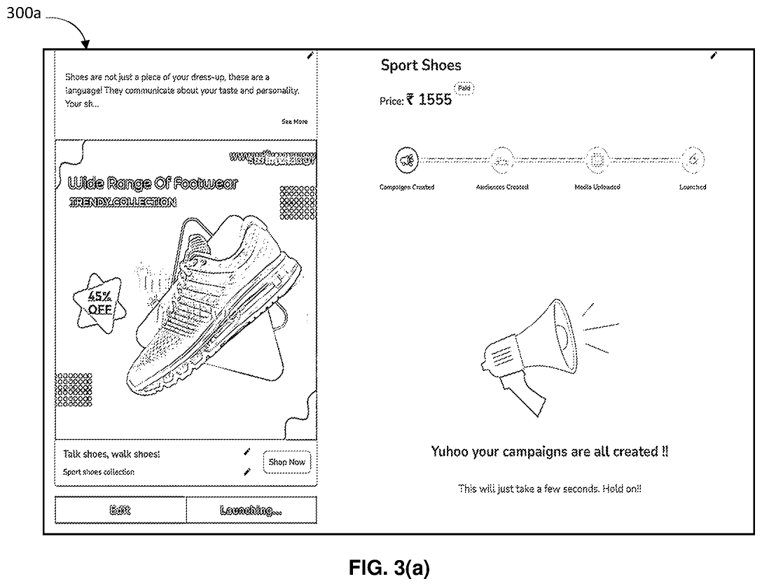

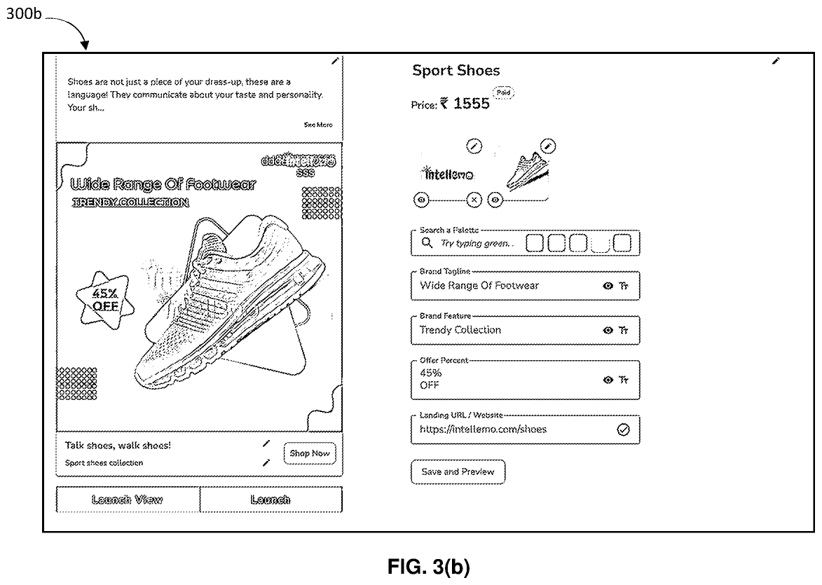

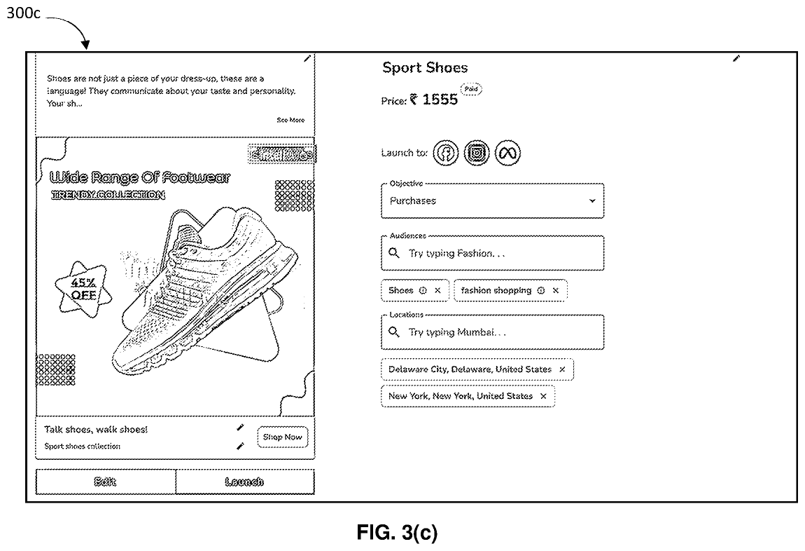

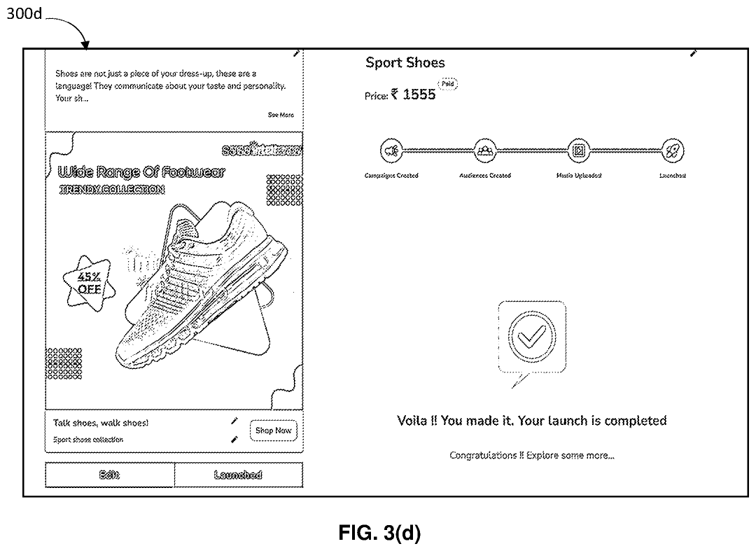

FIG. 3(a)-(d) illustrate an exemplary application flow for creating marketing campaign for a product and publishing the marketing campaign over multiple digital platforms, in accordance with some embodiments of the present disclosure.

In an embodiment of the present disclosure, an application for publishing marketing campaigns may be installed on a user device of the business owner. In another embodiment, the application may be web application hosted on internet. The business owner may signup with the business details and preferences on the application. In one non-limiting embodiment, the application may be a standalone application, or may be a “plug-in” to existing commercial social networking applications.

The business owner may provide a product/service-related information to the application and just at one click, the application generates a marketing campaign comprising an advertisement for the product/service to be launched on various digital platforms.

FIG. 3(a) shows an exemplary scenario 300a in which a readymade customized campaign is created for sport shoes. The campaign is created based on the business preferences of the business owner. As shown in FIG. 3(a), the business owner may edit the campaign by clicking on the edit button present on the bottom left corner, or the business owner may launch the campaign on multiple platforms through launch button.

FIG. 3(b) shows an exemplary scenario 300b where the business owner wants to edit the post. The business owner can now edit the various parameters of the campaigns including, but not limited to, a brand tagline, brand features, offer percentage, product details such a size and color, landing URL/website link. In one non-limiting embodiment of the present disclosure, the business may add upload additional images to the customized campaign. The business owner may save and preview the changes made to the campaign and allow the application to launch the campaign.

FIG. 3(c) shows an exemplary scenario 300c in which the business owner wants to change the campaign setting. The campaign setting may be based on the business preferences defined by the business owner at the time of sign up. The business owner may edit the target/objective, target audience, and preferred geographical locations for the campaign. The business owner may also select the digital platforms where they want to launch the campaign. In an exemplary embodiment, digital platforms include, but not limited to, Facebook, Instagram, Meta Ads Network, LinkedIn, Google Ads Network, YouTube, Pinterest, Quora, Twitter, TikTok, etc. In one non-limiting embodiment of the present disclosure, the campaign setting may be defined by the application based on the product/service for the which campaign is created.

FIG. 3(d) shows an exemplary scenario 300d in which the business owner launches the customized marketing campaign for the sport shoes by clicking the launch button after finalizing the post and campaign settings. In one non-limiting embodiment of the present disclosure, the application may launch the campaign immediately after creation based on an approval from the business owner.

Thus, the application provides a readymade content that gets automatically customized as per brand preferences of the business, thereby facilitating one click marketing to business owners where the campaigns are automatically created, targeting is set and ads are launched across multiple platforms.

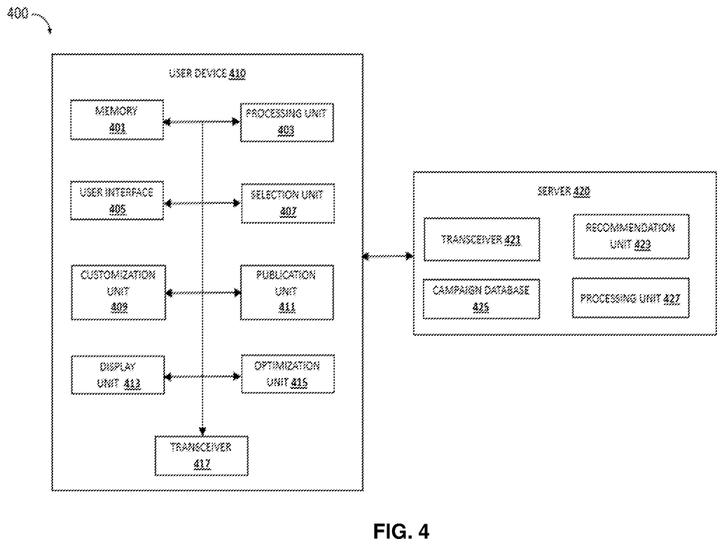

FIG. 4 illustrates a block diagram of a system 400 for publishing at least one marketing campaign over one or more digital platforms, in accordance with some embodiments of the present disclosure.

The system 400 may comprise a user device 410 and a server 420 connected over a communication network. The user device 410 may be a mobile phone, smart phone, mobile node, radio terminal, personal digital assistant, tablet computer, laptop computer, or the like with communication capabilities. The communication network may be the internet, intranet, a local area network (LAN), a wide area network (WAN), wireless LAN (WLAN), wireless fidelity (Wi-Fi), and similar networks.

The user device 410 may comprise a memory 401, a processing unit 403, a user interface 405, a selection unit 407, a customization unit 409, a publication unit 411, a display unit 413, an optimization unit 415, and a transceiver 417 in communication with each other. The server 420 may comprise a transceiver 421, a recommendation unit 423, a campaign database 425, and a processing unit 427 in communication with each other.

The memory 401 may be configured to store a plurality of instructions to be executed by the processing unit 403 for performing various functionalities of the user device 410. The user interface 405 may be configured to receive one or more parameters associated with at least one product or at least one service from a business owner for which a customized marketing campaign is to be created. The business owner may be a professional, content writer, or a marketer of a business.

In an embodiment, the one or more parameters may comprise an image associated with the at least one product or the at least one service, details associated with the at least one product or the at least one service, a target objective for the at least one product or the at least one service, target audience, location details, a type of content asset to be used, and a budget for marketing campaign.

The processing unit 403 may be configured to retrieve a plurality of marketing campaign recommendations associated with the at least one product or the at least one service from a database stored in the memory 401. The plurality of marketing campaign recommendations or readymade campaign templates may be related to different types of products, services, and business. These templates have their respective attributes, which may be mapped with the business preference of the business owner.

In one non-limiting embodiment of the present disclosure, the campaign database 425 of the server 420 may store the plurality of marketing campaign recommendations or readymade campaign templates and the processing unit 403 may be configured to retrieve the plurality of marketing campaign recommendations or readymade campaign templates from the server 420 for customization.

The processing unit 403 along with selection unit 407 may be configured select a marketing campaign recommendation from the plurality of marketing campaign recommendations at least based on one or more preferences of the business owner. The one or more preferences of the business owner is defined based at least on type of previous marketing campaigns selected by the business owner. In one non-limiting embodiment, the business preference may also comprise a type of marketing campaign, preferred digital platforms, daily budget for the marketing campaign, target audience, and goals of the business, etc. However, the business preferences are not limited to above example and any other business preference is well within the scope of present disclosure.

In one non-limited embodiment, the selection unit 407 may be trained using a machine learning technique for selecting a marketing campaign recommendation from the plurality of marketing campaign recommendations. In another non-limiting embodiment, the selection unit 407 may be trained using any other technique known to a person skilled in the art.

To select the marketing campaign recommendation from the plurality of marketing campaign recommendations, the processing unit 403 may be configured to compare the one or more preferences of the business owner with the attributes of each of the plurality of marketing campaign recommendations and determine the marketing campaign recommendation that matches the one or more preferences of the business owner. The selection may also be done based on the procedure discussed in above embodiments.

In one non-limiting embodiment of the present disclosure, the user device 410 may transmit the one or more parameters associated with the product/service to the server 420. The recommendation unit 423 of the server 420 may be configured to retrieve a plurality of marketing campaign recommendations associated with the at least one product or the at least one service from the campaign database 425. The recommendation unit 423 along with the processing unit 427 may be configured to select a marketing campaign recommendation from the available plurality of marketing campaign recommendations at least based on one or more preferences of the business owner. The one or more preference of the business owner may also be stored in the server 420. Then, the recommendation unit 423 may be configured to transmit the selected marketing campaign recommendation to the user device 410.

The processing unit 403 along with the customization unit 409 may be then configured to automatically customize the selected marketing campaign recommendation, at least based on metadata associated with the business owner and the one or more parameters, to generate a customized marketing campaign. The metadata associated with the business owner may comprise a brand logo, a brand color, a brand slogan/tagline, brand features, and URL/website link.

The customization of the selected marketing campaign recommendation may comprise applying a brand logo, a brand color, a brand slogan/tagline, brand features, and URL/website link to the selected marketing campaign. In other words, the customization may be done based on a brand configuration of the business.

The display unit 413 may be then configured to display the customized marketing campaign to the business owner. The user interface 405 may be configured to receive, from the business owner, one or more inputs on the customized marketing campaign displayed to the business owner. The one or more inputs may at least comprise one or more changes to be applied to the customized marketing campaign displayed to the business owner, or an approval on the customized marketing campaign for publishing on the one or more digital platforms. In one non-limiting embodiment, one or more digital platforms include, but not limited to, Facebook, Instagram, Meta Ads Network, LinkedIn, Google Ads Network, YouTube, Pinterest, Quora, Twitter, TikTok, etc.

The publication unit 411 along with the processing unit 403 may be configured to publish the customized marketing campaign on the one or more digital platforms based on the received one or more inputs. To publish the customized marketing campaign on the one or more digital platforms, the processing unit 403 may be configured to update the customized marketing campaign based on the one or more changes received from the business owner, and publish the updated marketing campaign on the one or more digital platforms. The one or more digital platforms for publishing the updated marketing campaign is selected by the business owner or may be recommended by the system 400. In one non-limiting embodiment, the customized marketing campaign may be directly published based on the approval of business owner.

In an embodiment of the present disclosure, the marketing campaign may comprise one or more of: a structure of campaign, audiences, keywords, product catalogue, service catalogue, and ads or ad sets across advertising manager dashboards of the one or more digital platforms.

In an embodiment of the present disclosure, the processing unit 403 along with the optimization unit 415 may be configured to automatically optimize the published marketing campaign at least based on a daily budget and a target objective of the business owner. The optimization unit 415 may comprise a budget engine for finding avenues and maximizing the revenue across platforms. The budget engine may optimize the published marketing campaign in terms of target audience, location and other preferences to increase the revenue of the business owner 201.

Thus, the system 400 provides a readymade content that gets automatically customized as per brand preferences of the business, thereby facilitating one click marketing platform to business owners where the campaigns are automatically created, targeting is set, and ads are launched across multiple platforms.

The units 407, 409, 411, 415, and 423 may be software units or hardware unit or combination of both. The units 407, 409, 411, 415, and 423 may comprise memory storing a plurality of instructions and a processor for executing the plurality of instruction. In one non-limiting embodiment of the present disclosure, the units 407, 409, 411, 415, and 423 may comprise a dedicated hardware circuitry for performing their respective functionalities, as discussed in above embodiments.

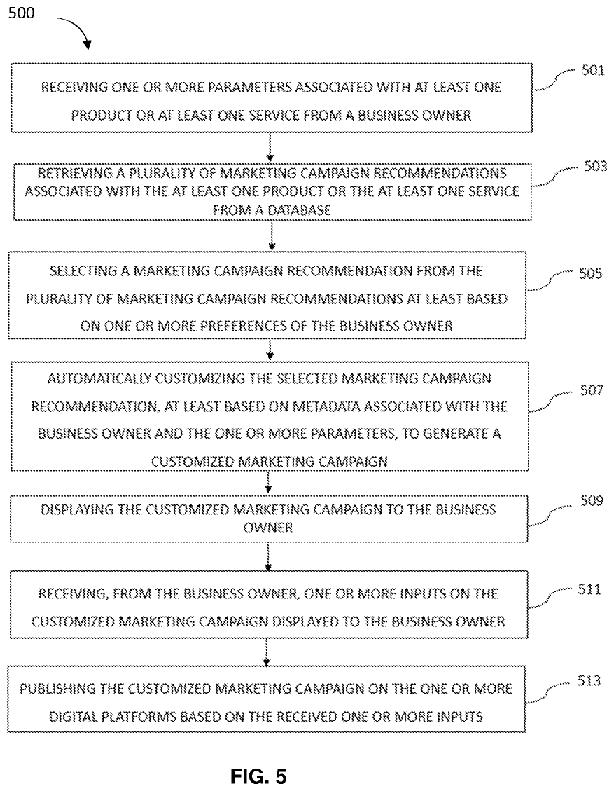

FIG. 5 depicts a flowchart illustrating an exemplary method 500 for publishing at least one marketing campaign over one or more digital platforms, in accordance with some embodiments of the present disclosure.

At block 501, one or more parameters associated with at least one product or at least one service may be received from a business owner for which a customized marketing campaign is to be created. The business owner may be a professional, content writer, or a marketer of a business. The one or more parameters may comprise an image associated with the at least one product or the at least one service, details associated with the at least one product or the at least one service, a target objective for the at least one product or the at least one service, target audience, location details, a type of content asset to be used, and a budget for marketing campaign.

At block 503, a plurality of marketing campaign recommendations associated with the at least one product or the at least one service may be retrieved from a database maintained in the memory of a user device. The plurality of marketing campaign recommendations or readymade campaign templates may be related to different types of products, services, and business. These templates have their respective attributes which may be mapped with the business preference of the business owner.

In one non-limiting embodiment of the present disclosure, the plurality of marketing campaign recommendations or readymade campaign templates may be stored at a server and the plurality of marketing campaign recommendations or readymade campaign templates may be retrieved from the server for customization.

At block 505, a marketing campaign recommendation from the plurality of marketing campaign recommendations may be selected at least based on one or more preferences of the business owner. The one or more preferences of the business owner is defined based at least on type of previous marketing campaigns selected by the business owner. In one non-limiting embodiment, the business preference may also comprise a type of marketing campaign, preferred digital platforms, target audience, daily budget for the marketing campaign, and goals of the business, etc. However, the business preferences are not limited to above example and any other business preference is well within the scope of present disclosure.

The selection of the marketing campaign recommendation from the plurality of marketing campaign recommendations may comprises comparing the one or more preferences of the business owner with the attributes of each of the plurality of marketing campaign recommendations and determining the marketing campaign recommendation that matches the one or more preferences of the business owner. The selection may also be done based on the procedure discussed in above embodiments.

In one non-limiting embodiment of the present disclosure, the one or more parameters associated with the product/service may be transmitted to the server. The server may retrieve a plurality of marketing campaign recommendations associated with the at least one product or the at least one service from the server database. The server may then select or recommend a marketing campaign recommendation from the plurality of marketing campaign recommendations at least based on one or more preferences of the business owner. The one or more preference of the business owner may also be stored in the server. Then, the recommendation may be transmitted to the user device of the business owner.

At block 507, the selected marketing campaign recommendation may be automatically customized, at least based on metadata associated with the business owner and the one or more parameters, to generate a customized marketing campaign. The metadata associated with the business owner may comprise a brand logo, a brand color, a brand slogan/tagline, brand features, and URL/website link.

The customization of the selected marketing campaign recommendation may comprise applying a brand logo, a brand color, a brand slogan/tagline, brand features, and URL/website link to the selected marketing campaign. In other words, the customization may be done based on a brand configuration of the business.

At block 509, the customized marketing campaign to the business owner may be displayed to the business owner on the user device. At block 511, one or more inputs on the customized marketing campaign displayed to the business owner may be received from the business owner. The one or more inputs may at least comprise one or more changes to be applied to the customized marketing campaign displayed to the business owner, or an approval on the customized marketing campaign for publishing on the one or more digital platforms. In one non-limiting embodiment, one or more digital platforms include, but not limited to, Facebook, Instagram, Meta Ads Network, LinkedIn, Google Ads Network, YouTube, Pinterest, Quora, Twitter, TikTok, etc.

At block 513, the customized marketing campaign may be published on the one or more digital platforms based on the received one or more inputs. The publishing of the customized marketing campaign on the one or more digital platforms may comprise updating the customized marketing campaign based on the one or more changes received from the business owner, and publishing the updated marketing campaign on the one or more digital platforms.

The one or more digital platforms for publishing the updated marketing campaign is selected by the business owner or may be recommended to the business owner. In one non-limiting embodiment, the customized marketing campaign may be directly published based on the approval of business owner.

In an embodiment of the present disclosure, the marketing campaign may comprise one or more of: a structure of campaign, audiences, keywords, product catalogue, service catalogue and ads or ad sets across advertising manager dashboards of the one or more digital platforms.

The method 500 may further comprise automatically optimizing the published marketing campaign at least based on a daily budget and a target objective of the business owner. A budget engine may be configured for finding avenues and maximizing the revenue across platforms. The budget engine may optimize the published marketing campaign in terms of target audience, location and other preferences to increase the revenue of the business owner.

Thus, the method 500 provides a readymade content that gets automatically customized as per brand preferences of the business, thereby facilitating one click marketing platform to business owners where the campaigns are automatically created, targeting is set, and ads are launched across multiple platforms.

In another non-limiting embodiment of the present disclosure, the steps of method 500 may be performed in an order different from the order described above.

Thus, the platform disclosed in the present invention does not recreate versions of graphics just on basis of an external inspiration. Instead, the platform enables a professional designer, a content writer and a marketer to create what's recommended to perform by advertising for a product or service of a brand. The platform then matches them to brand preferences and customizes the design to incorporate the product image, model, logo and brand colors. Thereafter, once the brand advertiser publishes it creates a structure of campaigns, audiences, keywords, product catalogue, service catalogue and ads across advertising manager dashboards of platforms (such as Facebook, LinkedIn, Google, etc.). The campaign, target audience, location and other preferences are automatically set to achieve highest revenue for ad spend.

Further, the platform disclosed in the present invention is not just for budget optimization. Instead, the platform comprises readymade campaigns including advertisement design, content and recommended audiences. The different brand can use their own website or landing pages for tracking using available tracking tools like Google Analytics (their reporting is integrated within our platform for a single reporting interface). Even budget engine of the present flatform works at brand level and not just at campaign level, to find various avenues and maximize the revenue across campaigns across platforms.

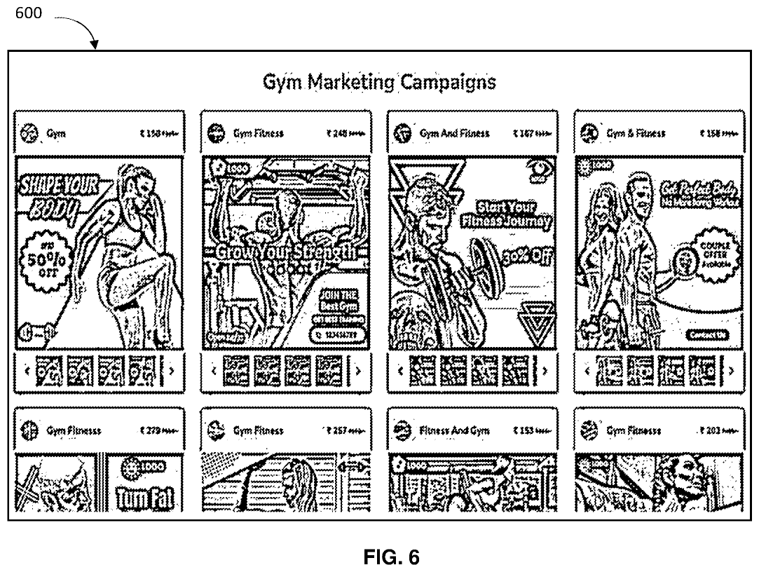

FIG. 6 illustrate an exemplary application window 600 for searching and selecting a campaign recommendation from a plurality of campaign recommendations, in accordance with some embodiments of the present disclosure.

In an embodiment of the present disclosure, the business owner may search for campaign recommendations from a search tab provided on the application platform. In an exemplary embodiment, the business owner may search for Gym Marketing Campaigns and may be taken to the application window 600, wherein the business owner is provided with a plurality of Gym Marketing Campaign recommendations. The business owner may tap and select campaign of his/her choice. The application platform may apply the brand configuration of the business owner to the customize to the selected campaign and generate a customized marketing campaign for launching on the plurality of digital marketing platforms such as Facebook, Instagram, Meta Ads Network, LinkedIn, Google Ads Network, YouTube, Pinterest, Quora, Twitter, TikTok, etc.

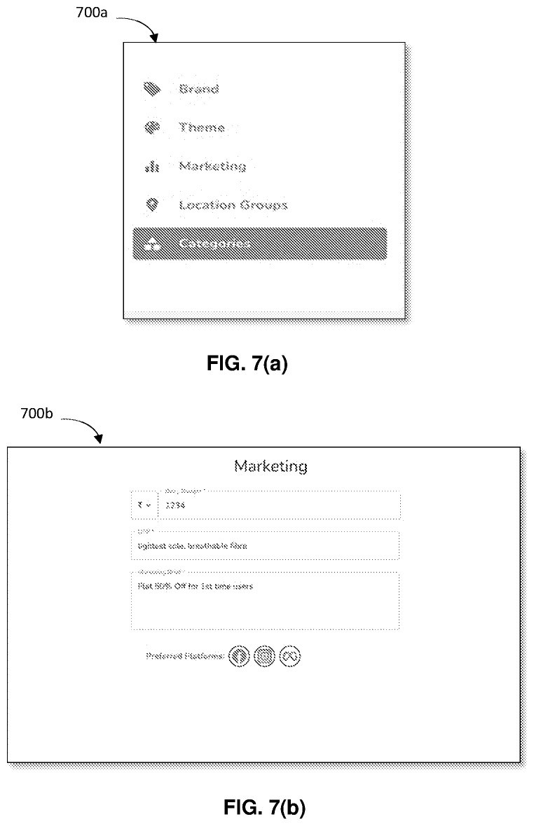

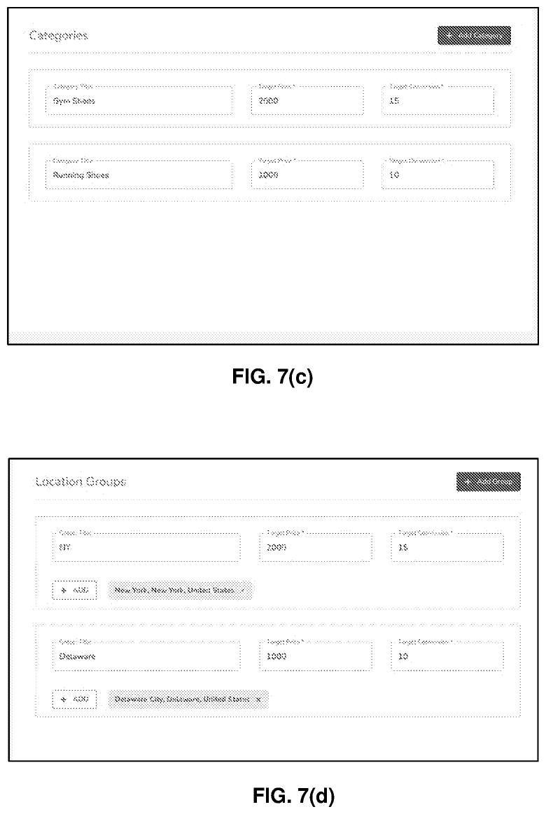

FIG. 7(a)-(d) illustrate exemplary application window for budgeting ad goals at various levels, in accordance with some embodiments of the present disclosure.

FIG. 7(a) shows an application window 700a in accordance with the present disclosure. The user of the application or the business owner is presented with plurality of options for selection and customization. In an embodiment, the business owner is presented with an option of brand, theme, marketing, location groups and categories for selection.

FIG. 7(b) shows an application window 700b for setting a budget for marketing. The business owner may provide inputs on the daily budget, the USP of the product/service, and offers related to the product/service. The business owner may also be provided with an option of selecting the preferred platform for launching the digital marketing campa.

FIG. 7(c) shows an application window 700c for setting category level budget ad goals. In the category level budget goals setting, the business owner may select/provide the category title and set the target price and the target conversion based on the business goals of the business owner. In an exemplary embodiment, the business owner has a shoe business and the business owner may select category title such as gym shoes, running shoes, etc., along with their respective target price and the total target conversion for the marketing campaign.

FIG. 7(d) shows an application window 700d for setting location group level budget ad goals. In the location group level goals setting, the business owner may select/provide the group titles and set the target price and the targeted conversion. In an exemplary embodiment, the business owner may select New York and Delaware location groups and set their respective target price and the total target conversion for the marketing campaign.

Thus, the application platform 700(a-d) allows the business owners to set their budget ad goals by using various levels of customization options present on the application platform. Thus, business owner may customize the marketing campaign goals at different levels as per the business preferences.

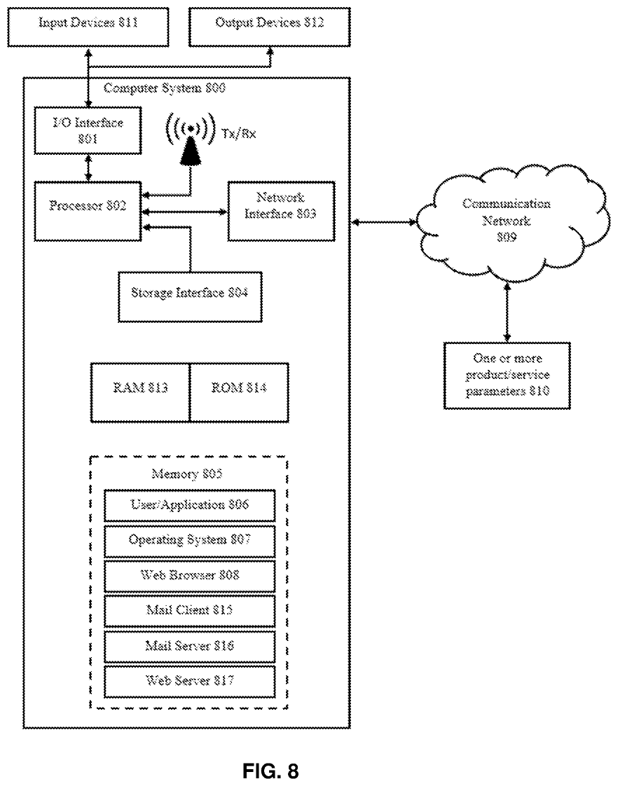

FIG. 8 illustrates a block diagram illustrating an exemplary computer system 800 for implementing embodiments consistent with the present disclosure.

In an embodiment, the computer system 800 can be system 103, 203, 400, which is used for publishing at least one marketing campaign over one or more digital platforms. According to an embodiment, the computer system 800 may receive appliance data 810 which may include, for example, one or more parameters associated with at least one product or at least one service for which a customized marketing campaign is to be created. The computer system 800 may comprise a central processing unit (“CPU” or “processor”) 802. The processor 802 may comprise at least one data processor for executing program components for executing user- or system-generated business processes. The processor 802 may include specialized processing units such as integrated system (bus) controllers, memory management control units, floating point units, graphics processing units, digital signal processing units, etc.

The processor 802 may be disposed in communication with one or more input/output (I/O) devices (811 and 812) via I/O interface 801. The I/O interface 801 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 801, the computer system 800 may communicate with one or more I/O devices (811 and 812).

In some embodiments, the processor 802 may be disposed in communication with a communication network 809 via a network interface 803. The network interface 803 may communicate with the communication network 809. The network interface 803 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 809 can be implemented as one of the different types of networks, such as intranet or Local Area Network (LAN) and such within the organization. The communication network 809 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 809 may include a variety of network devices, including routers, bridges, servers, computing devices, storage devices, etc.

In some embodiments, the processor 802 may be disposed in communication with a memory 805 (e.g., RAM 813, ROM 814, etc. as shown in FIG. 8) via a storage interface 804. The storage interface 804 may connect to memory 805 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 805 may store a collection of program or database components, including, without limitation, user/application data 806, an operating system 807, web browser 808 etc. In some embodiments, the computer system 800 may store user/application data 806, such as the data, variables, records, etc. as described in this invention. Such databases may be implemented as fault-tolerant, relational, scalable, secure databases such as Oracle or Sybase.

The operating system 807 may facilitate resource management and operation of the computer system 800. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. I/O interface 801 may facilitate display, execution, interaction, manipulation, or operation of program components through textual or graphical facilities. For example, I/O interface may provide computer interaction interface elements on a display system operatively connected to the computer system 800, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 800 may implement a web browser 808 stored program component. The web browser 808 may be a hypertext viewing application, such as Microsoft™ Internet Explorer, Google™ Chrome, Mozilla™ Firefox, Apple™ Safari™ etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 800 may implement a mail server stored program component. The mail server 816 may be an Internet mail server such as Microsoft Exchange, or the like. The mail server 816 may utilize facilities such as Active Server Pages (ASP), ActiveX, American National Standards Institute (ANSI) C++/C #, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 800 may implement a mail client 815 stored program component. The mail client 815 may be a mail viewing application, such as Apple™ Mail, Microsoft™ Entourage, Microsoft™ Outlook, Mozilla™ Thunderbird, etc.

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

In a non-limiting embodiment of the present disclosure, one or more non-transitory computer-readable media may be utilized for implementing the embodiments consistent with the present disclosure. A computer-readable media refers to any type of physical memory (such as the memory) on which information or data readable by a processor may be stored. Thus, a computer-readable media may store one or more instructions for execution by the at least one processor, including instructions for causing the at least one processor to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the disclosure(s)” unless expressly specified otherwise.

The various exemplary logical blocks and modules described in connection with the embodiments disclosed herein can be implemented or executed by a machine such as a processor. The processor may be a microprocessor, but alternatively, the processor may be a controller, a microcontroller, or a state machine, or a combination thereof. The processor can include an electrical circuit configured to process computer executable instructions. In another embodiment, the processor includes an application specific integrated circuit (ASIC), a field programmable gate array (FPGA), or other programmable device that performs logical operations without processing computer executable instructions. The processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processor may also include primarily analog components. For example, some or all of the signal processing algorithms described herein may be implemented by analog circuitry or mixed analog and digital circuitry. A computing environment may include any type of computer system, including, but not limited to, a computer system that is based on a microprocessor, mainframe computer, a digital signal processor, a portable computing device, device controller or a computing engine within the device.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

What is claimed is:

1. A method of publishing at least one marketing campaign over one or more digital platforms, the method comprising:
receiving one or more parameters associated with at least one product or at least one service from a business owner;
retrieving a plurality of marketing campaign recommendations associated with the at least one product or the at least one service from a database, wherein each marketing campaign recommendation comprises a pre-built design, content, target audience and configuration;
selecting a marketing campaign recommendation from the plurality of marketing campaign recommendations at least based on one or more preferences of the business owner;
automatically customizing the selected marketing campaign recommendation, at least based on metadata associated with the business owner and the one or more parameters, to generate a customized marketing campaign;
displaying the customized marketing campaign to the business owner;
receiving, from the business owner, one or more inputs on the customized marketing campaign displayed to the business owner; and
publishing the customized marketing campaign on the one or more digital platforms based on the received one or more inputs.

2. The method of claim 1, wherein selecting the marketing campaign recommendation from the plurality of marketing campaign recommendations comprises:
comparing the one or more preferences of the business owner with each of the plurality of marketing campaign recommendations; and
determining the marketing campaign recommendation that matches the one or more preferences of the business owner.

3. The method of claim 1, wherein the one or more parameters comprises an image associated with the at least one product or the at least one service, details associated with the at least one product or the at least one service, a target objective for the at least one product or the at least one service, target audience, location details, and a budget for marketing campaign.

4. The method of claim 1, wherein the metadata associated with the business owner comprises a brand logo, a brand color, a brand slogan/tagline, brand features, and URL/website link.

5. The method of claim 1, wherein the one or more preferences of the business owner is defined based at least on type of previous marketing campaigns selected by the business owner.

6. The method of claim 1, wherein the one or more inputs at least comprises one or more changes to be applied to the customized marketing campaign displayed to the business owner.

7. The method of claim 6, wherein publishing the customized marketing campaign on the one or more digital platforms comprises:
updating the customized marketing campaign based on the one or more changes received from the business owner; and
publishing the updated marketing campaign on the one or more digital platforms, wherein the one or more digital platforms for publishing the updated marketing campaign is selected by the business owner.

8. The method of claim 1, wherein one or more inputs comprises an approval on the customized marketing campaign for publishing on the one or more digital platforms.

9. The method of claim 1, further comprising:
automatically optimizing the published marketing campaign at least based on a daily budget and a target objective of the business owner.

10. The method of claim 1, wherein the marketing campaign comprises one or more of: a structure of campaign, audiences, keywords, product catalogue, service catalogue and ads or ad sets across advertising manager dashboards of the one or more digital platforms.

11. A system for publishing at least one marketing campaign over one or more digital platforms, comprising:
a memory for storing a plurality of instructions;
a processing unit in communication with the memory capable of executing the plurality of instructions; and
a user interface in communication with the memory and the processing unit, the user interface configured to receive one or more parameters associated with at least one product or at least one service from a business owner;
wherein the processing unit is configured to:
retrieve a plurality of marketing campaign recommendations associated with the at least one product or the at least one service from a database, wherein each marketing campaign recommendation comprises a pre-built design, content, target audience and configuration;
select a marketing campaign recommendation from the plurality of marketing campaign recommendations at least based on one or more preferences of the business owner; and
automatically customize the selected marketing campaign recommendation, at least based on metadata associated with the business owner and the one or more parameters, to generate a customized marketing campaign;
wherein the system further comprises:
a display unit configured to display the customized marketing campaign to the business owner,
wherein the user interface is configured to receive, from the business owner, one or more inputs on the customized marketing campaign displayed to the business owner, and
wherein the processing unit is configured to publish the customized marketing campaign on the one or more digital platforms based on the received one or more inputs.

12. The system of claim 11, wherein to select the marketing campaign recommendation from the plurality of marketing campaign recommendations, the processing unit is configured to:
compare the one or more preferences of the business owner with each of the plurality of marketing campaign recommendations; and
determine the marketing campaign recommendation that matches the one or more preferences of the business owner.

13. The system of claim 11, wherein the one or more parameters comprises an image associated with the at least one product or the at least one service, details associated with the at least one product or the at least one service, a target objective for the at least one product or the at least one service, target audience, location details, and a budget for marketing campaign.

14. The system of claim 11, wherein the metadata associated with the business owner comprises a brand logo, a brand color, a brand slogan/tagline, brand features, and URL/website link.

15. The system of claim 11, wherein the one or more preferences of the business owner is defined based at least on type of previous marketing campaigns selected by the business owner.

16. The system of claim 11, wherein the one or more inputs at least comprises one or more changes to be applied to the customized marketing campaign displayed to the business owner, or an approval on the customized marketing campaign for publishing on the one or more digital platforms.

17. The system of claim 16, wherein to publish the customized marketing campaign on the one or more digital platforms, the processing unit is configured to:
update the customized marketing campaign based on the one or more changes received from the business owner; and
publish the updated marketing campaign on the one or more digital platforms, wherein the one or more digital platforms for publishing the updated marketing campaign is selected by the business owner.

18. The system of claim 11, wherein the processing unit is configured to:
automatically optimize the published marketing campaign at least based on a daily budget and a target objective of the business owner.

19. The system of claim 11, wherein the marketing campaign comprises one or more of: a structure of campaign, audiences, keywords, product catalogue, service catalogue and ads or ad sets across advertising manager dashboards of the one or more digital platforms.

20. A non-transitory computer-readable medium having computer-readable instructions that when executed by a processor causes the processor to perform operations of:
obtaining one or more parameters associated with at least one product or at least one service from a business owner;
retrieving a plurality of marketing campaign recommendations associated with the at least one product or the at least one service from a database, wherein each marketing campaign recommendation comprises a pre-built design, content, target audience and configuration;
selecting a marketing campaign recommendation from the plurality of marketing campaign recommendations at least based on one or more preferences of the business owner;
automatically customizing the selected marketing campaign recommendation, at least based on metadata associated with the business owner and the one or more parameters, to generate a customized marketing campaign;
displaying the customized marketing campaign to the business owner;
obtaining, from the business owner, one or more inputs on the customized marketing campaign displayed to the business owner; and
publishing the customized marketing campaign on the one or more digital platforms based on the received one or more inputs.
